(19) United States
(12) Patent Application Publication
(10) Pub. No.: US 2004/0206404 A1
(43) Pub. Date: Oct. 21, 2004

(54) Rotatable ball valve assembly

(76) Inventor: Chih-Hung Yang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/419,211

(22) Filed: Apr. 21, 2003

(51) Int. Cl. F16K 15/18

(52) U.S. Cl. 137/614.17

(57) ABSTRACT

A ball valve assembly includes a housing with a ball valve rotatably received therein and an adjusting shaft extends through a wall of the housing and is connected to the ball valve. A passage is defined through the ball valve and a separation bar is connected to an inner periphery of the passage so as to define a first partition and a second partition in the passage. A seal member is located in the first partition of the passage and a control device is connected to the seal member which movably seals the passage. The ball valve is rotated an angle by rotating the adjusting shaft so that the direction of the flow of the liquid via the ball valve can be changed.

### FIELD OF THE INVENTION

The present invention relates to a rotatable ball valve assembly which is rotated an angle so as to control the directions of the liquid flow.

### BACKGROUND OF THE INVENTION

A conventional piping system for a water reservoir located at a top of a building is disclosed in FIG. 10 and generally includes a pipe D which is connected to a pump A which sends water from a lower place to the water reservoir at a higher place. A valve B is connected to the pipe D so as to prevent the water from going back to the lower place. A one-direction member is located in the valve B which is pushed to open by the pressure of the water when the pump A pumps water to the reservoir, and is closed when the pump A is turned off. When the pipe D needs to be replaced or maintained, there will be some water stayed in the pipe D between the valve B and a bending portion of the pipe D. The water stayed in the pipe D flows to the floor when removing the pipe D away from the reservoir and the valve B. This makes the floor be slippery. If the piping system is used for an oil piping system, the section of the oil stayed in the pipe flows to the ground and could get fire.

The present invention intends to provide a valve ball assembly which may rotate the valve a desired angle so that the section of the liquid stayed in the pipe can flow back to the source.

### SUMMARY OF THE INVENTION

In accordance with one aspect of the present invention, there is provided a ball valve assembly which comprises a housing and an adjusting shaft extends through a wall of the housing and a driving member is connected to the adjusting shaft. A ball valve is rotatably received in the interior of the housing and the driving member is engaged with a notch defined in an outer periphery of the ball valve 20 so that the ball valve can be rotated an angle by rotating the adjusting shaft. A passage is defined through the ball valve and a separation bar is connected to an inner periphery of the passage so as to define a first partition and a second partition in the passage. A seal member is located in the first partition of the passage and a control device is connected to the seal member which movably seals the passage.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the ball valve assembly of the present invention;

FIG. 1 is a perspective view to show the ball valve assembly of the present invention;

FIG. 3 shows the seal member is pushed to open the ball valve by liquid flow in the ball valve assembly of the present invention;

FIG. 4 shows the seal member seals the ball valve when the pressure of the liquid flow disappeared;

FIG. 5 shows the ball valve is rotated 180 degrees and the seal member is pushed to open the ball valve;

FIGS. 6A, 6B, 6C and 6D show the ball valve is rotated different angles;

FIG. 7 shows another embodiment of the seal member and the control device of the ball valve assembly of the present invention;

FIG. 8 is a cross sectional view to show the seal member in FIG. 7 is opened;

FIG. 9 shows yet another embodiment of the seal member and the control device of the ball valve assembly of the present invention, and

FIG. 10 shows a conventional piping system for a water reservoir.

### DETAILED DESCRIPTION OF THE PREFERRED EMBODIMENT

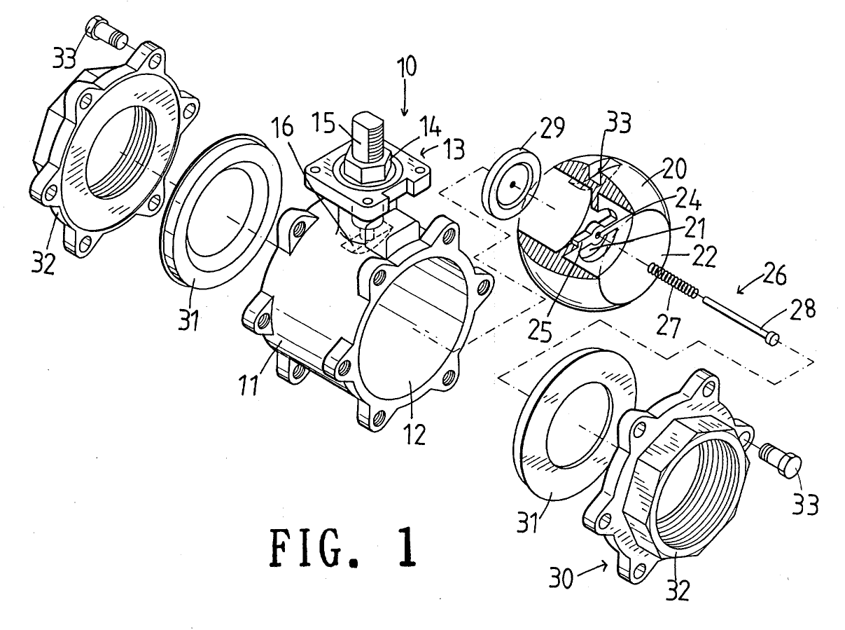

Referring to FIGS. 1 and 2, the ball valve assembly 10 of the present invention comprises a housing 11 which is connected between two end connection sets 30. Each end connection set 30 includes a packing 31 and a connection member 32 which is fixed to two ends of the housing 11 by bolts 33 and includes a threaded inner periphery. An adjusting device 13 includes a shaft 15 which extends through a wall of the housing 11 and is positioned by a nut 14. A driving member 16 is connected to the adjusting shaft 15 and located in an interior 12 of the housing 11.

A ball valve 20 is rotatably received in the interior 12 of the housing 11 and a notch 23 is defined in an outer periphery of the ball valve 20. The driving member 16 is engaged with the notch 23. A passage 22 is defined through the ball valve 20 and a separation bar 25 is connected to an inner periphery of the passage 22 so as to define a first partition and a second partition in the passage 22. Two openings 21 are in communication with the two partitions in the passage 22.

A seal member 29 is located in the first partition of the passage 22 and a control device 26 is connected to the seal member 29 which movably seals the two openings 21 in the passage 22. The control device 26 includes a pin 28 which movably extends through a hole 24 defined through the separation bar 25 and a spring 27 is mounted to the pin 28 and biased between the separation bar 25 and a head of the pin 28.

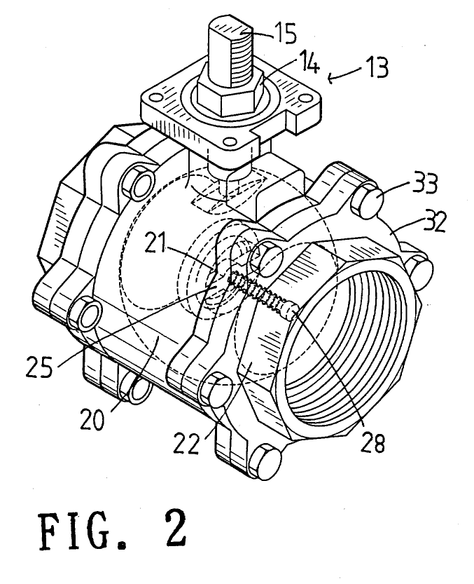

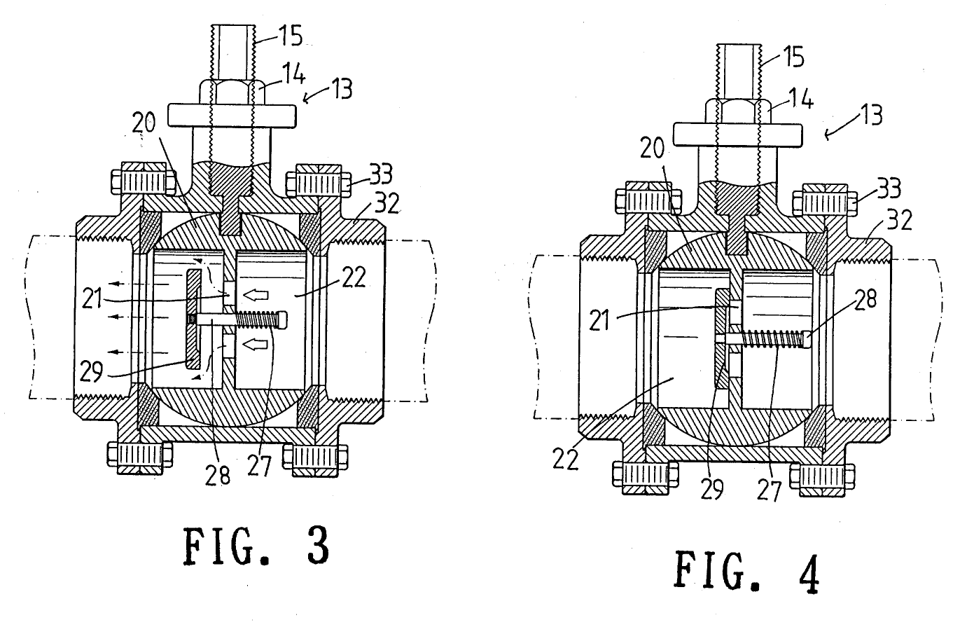

Referring to FIGS. 3 and 4, when the liquid is pumped, the pressure of the liquid pushes the seal member 29 away from the separation bar 25 so that the liquid flows from the second partition to the first partition. After the pressure is disappeared, the spring 27 pulls the seal member 29 to seal the openings 21 again.

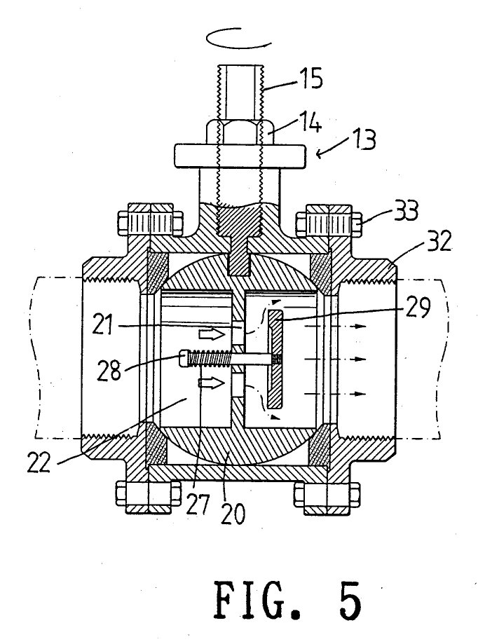

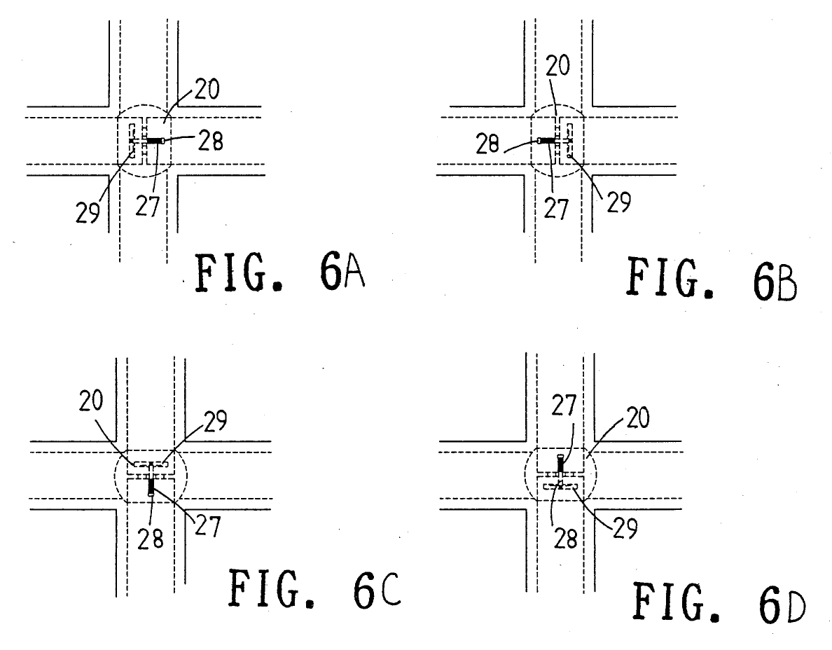

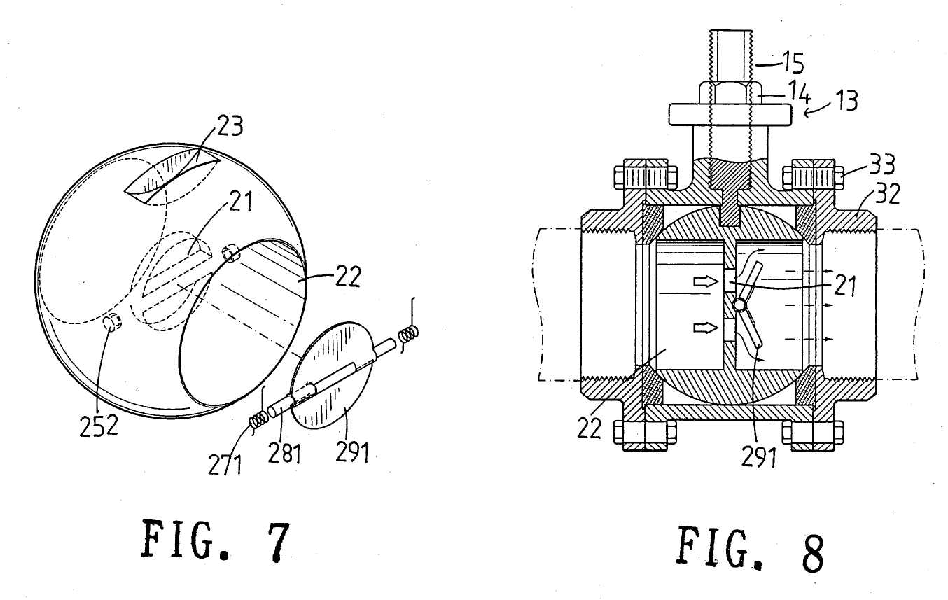

FIG. 5 shows that the ball valve 20 is rotated 180 degrees by rotating the adjusting shaft 15 so that the direction of the liquid flow can be changed. FIGS. 6A to 6D show that the angles that the ball valve 20 is rotated can be set according to needs in four-way connection.

FIG. 7 shows another embodiment of the ball valve assembly of the present invention, wherein the seal member 29 includes two parts 291 which are connected with each other side by side by the control device. The control device has a pin 281 which extends through a path 252 defined through wall of the ball valve 20 and the two parts 291 with a torsion spring 271 mounted to the pin 281. As shown in FIG. 8, the two parts 291 are respectively pivoted to open the openings 21 by the liquid flow.

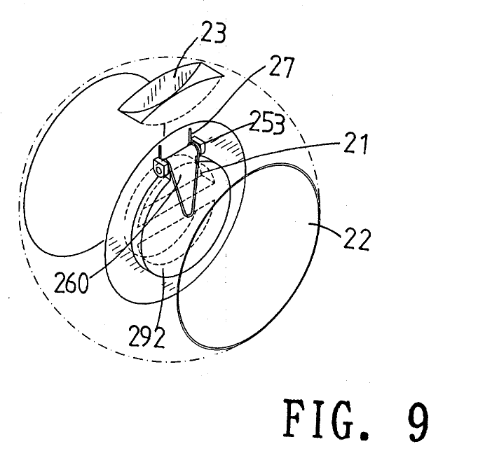

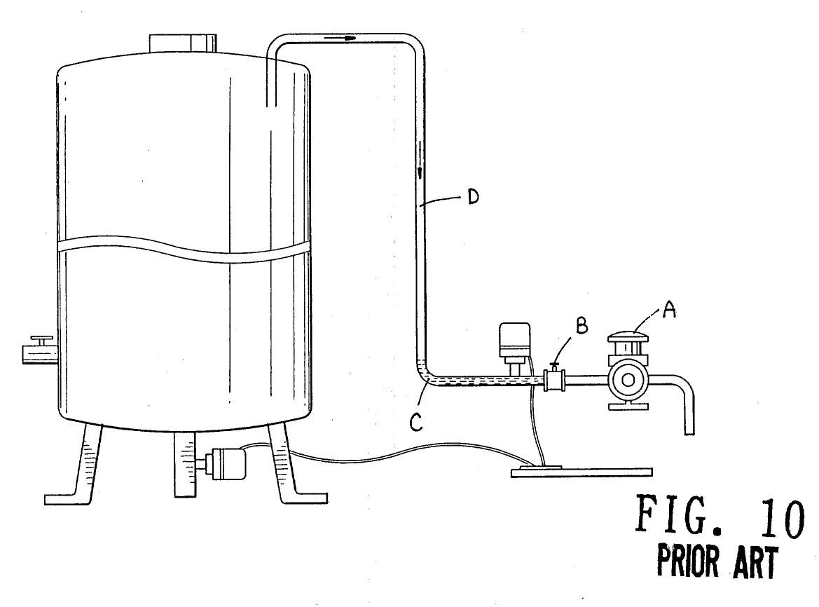

FIG. 9 shows yet another embodiment of the ball valve assembly of the present invention, wherein the control device includes two lugs 253 and a plate 260 is pivotably connected between the two lugs 253 by a pin. The plate 260 is connected to the seal member 292 so that the seal member 292 can be opened and closed by the torsion springs 27 mounted to the pin.

While we have shown and described the embodiment in accordance with the present invention, it should be clear to those skilled in the art that further embodiments may be made without departing from the scope of the present invention.

What is claimed is:

1. A ball valve assembly comprising:
a housing and an adjusting shaft extending through a wall of the housing, a driving member connected to the adjusting shaft and located in an interior of the housing;
a ball valve rotatably received in the interior of the housing and a notch defined in an outer periphery of the ball valve, the driving member engaged with the notch, a passage defined through the ball valve and a separation bar connected to an inner periphery of the passage so as to define a first partition and a second partition in the passage, and
a seal member located in the first partition of the passage and a control device connected to the seal member which movably seals the passage.

2. The ball valve assembly as claimed in claim 1, wherein the control device includes a pin which movably extends through a hole defined through the separation bar, a spring mounted to the pin and biased between the separation bar and a head of the pin.

3. The ball valve assembly as claimed in claim 1, wherein the seal member includes two parts which are connected with each other side by side by the control device, the control device having a pin which extends through a wall of the ball valve and the two parts with a torsion spring mounted to the pin.

4. The ball valve assembly as claimed in claim 1, wherein the control device includes two lugs and a plate is pivotably connected between the two lugs, the plate connected to the seal member.
